(19) United States
(12) Patent Application Publication
(10) Pub. No.: US 2011/0270678 A1
(43) Pub. Date: Nov. 3, 2011

(54) SYSTEM AND METHOD FOR USING REAL-TIME KEYWORDS FOR TARGETING ADVERTISING IN WEB SEARCH AND SOCIAL MEDIA

(76) Inventors: Mark E. Drummond, Los Altos Hills, CA (US); David B. Hills, San Francisco, CA (US); Susan M. Doherty, Redwood City, CA (US); William York, Los Altos Hills, CA (US); Boris Agapiev, Portland, OR (US); Nikola Todorovic, Nis (RS); Aleksandar Ilic, Nis (RS); Jonathan Ewert, Westport, CT (US); Stephanie Fulqui, Pacifica, CA (US); Steven T. Jurvetson, Menlo Park, CA (US); Stephanie A. Sarka, New York, NY (US)

(21) Appl. No.: 13/099,051

(22) Filed: May 2, 2011

Related U.S. Application Data
(60) Provisional application No. 61/330,550, filed on May 3, 2010.

(51) Int. Cl. G06Q 30/00; G06F 17/30; G06F 7/00

(52) U.S. Cl. 705/14.52; 707/769; 707/722; 707/706; 707/765; 705/14.49; 705/27.1; 707/E17.108

(57) ABSTRACT

As the result of a keyword search, real time and social news stream Web search results are retrieved and analyzed to build a topic model of n-grams. The n-grams of the topic model are treated as ad-based keywords to determine advertisements to be displayed in conjunction with the real time Web search results. The real time Web search results and the advertisements are then be presented or displayed for user consumption or review.

### RELATED APPLICATIONS

This is a NONPROVISIONAL of and claims priority to U.S. Provisional Patent Application No. 61/330,550 filed 3 May 2010, which is incorporated herein by reference.

### FIELD OF THE INVENTION

The present invention relates to methods and systems for statistical processing of search results returned in response to a search query to build a topic model of n-grams that are present in documents included in the search results, where the n-grams may be used both as subsequent search queries for a user and also as potential triggers for the presentation of on-line advertisements.

### BACKGROUND

The advent of “every-man” content publishing tools for the World Wide Web (the “Web”), the graphical user interface of the network of networks known as the Internet, has given rise to the “real time Web”—a set of technologies and practices that allow content consumers to receive information as soon as, or nearly so, it is published by content authors. That is, rather than having to rely on crawlers or other software agents to explore the Web and locate new content items, a process which may take hours or even days, content consumers are often on the receiving end of “push” technologies which broadcast content to the consumers in near real time as it is published to the Web. Facebook™ newsfeeds and Twitter™ tweets are some well-known examples of these real time Web technologies. The user experience inside such services if often based on a the idea of a newsfeed; that is, on an ever-changing sequence of results, delivered in real-time or near-real-time.

Despite the ever-increasing amount and importance of real time Web content, Internet search tools have, for the most part, remained focused on curated Web content. Where traditional search engines have sought to incorporate real time Web content in search results, the end result has been disappointing. This is perhaps not surprising inasmuch as conventional search engines rely on crawls of Web sites to produce indicies of those sites and then return search results based on the relevance of those indices to keywords in search queries. Such methodologies do not work particularly well in an environment such as the real time Web, where content and context both change rapidly.

### SUMMARY OF THE INVENTION

In one embodiment, the present invention provides for receipt of a search keyword at a first computer system, and in response thereto, retrieval of real time Web search results for the search keyword. The real time Web search results are analyzed to build a topic model of n-grams, and the n-grams of the topic model are treated as ad-based keywords to determine advertisements to be displayed in conjunction with the real time Web search results. The real time Web search results and the advertisements may then be presented or displayed for user consumption or review.

### BRIEF DESCRIPTION OF THE DRAWINGS

The present invention is illustrated by way of example, and not limitation, in the figures of the accompanying drawings, in which:

FIGS. 1 and 2 are screen shots illustrating how search results of an Internet-based search engine responsive to a keyword search may differ from one day to another and thereby affect sponsored advertisements presented alongside the search results;

FIG. 3 is a graph illustrating the concept of the information value of time; that is, a measure of popular interest in a particular event relative to the time of occurrence of the event;

FIG. 4 illustrates a process for statistical processing of search results returned by an Internet-based search engine in response to a search query to build a topic model of n-grams which may be used as potential keyword-based search queries for the presentation of on-line advertisements in accordance with an embodiment of a present invention;

FIG. 5 is a screen shot illustrating search results obtained from an Internet-based search engine in response to user selection of a predefined category of real time Web content as a shorthand method of seeking a list of search results showing real time Web content related to that category;

FIG. 6 illustrates an example of a real time keyword extension tool which receives a vector of keywords and, in response, outputs an expanded set of keywords in accordance with an embodiment of the present invention; and

FIG. 7 illustrates a computer system upon or with which the methods of the present invention may be practiced.

### DETAILED DESCRIPTION

In various embodiments, the present invention provides methods and systems for statistical processing of a news feed, either a raw newsfeed, or a filtered news feed that could be obtained by applying a search operation. These systems and methods provide means for contextual advertising targeting, for example by manufacturing and harnessing intent in conversational media.

News streams of interest in the context of the invention may include the raw news feed of services such as Facebook, Twitter, and LinkedIn, and news streams that result from filtering operations of the sort provided by search functionality. Text in a news feed (raw or filtered by search) is processed using statistical language techniques to build a topic model of n-grams that are present in the text (and in documents referred to by pointers such as uniform resource locators (URLs) in the text); these n-grams may be subsequently used as search queries by a user and also as potential triggers for the presentation of on-line advertisements. Embodiments of the present invention thus provide means for determining what a news stream is ‘about’, and presenting that information to the user in an actionable way; when a user acts on an element of the topic summary, the user is conducting a search. This is why we say that the present invention provides means for manufacturing intent (topic model synthesis) and harnessing intent (giving a user a chance to click on or otherwise select a topic). The present invention delivers effective advertising in social media, resulting in search-like performance in terms of click-through rates.

In various embodiments of the invention, the processing of a feed builds a topic model of n-grams that are present in documents included in the raw news feed or filtered news feed, where the n-grams may be used both as subsequent search queries for a user and also as potential triggers for the presentation of on-line advertisements. The present invention is especially useful in the context of the real time Web and, more specifically, real time social search (i.e., searches performed in a user's social newsfeed). Real time search is distinct from “reference search”, as is afforded by traditional search engines. The user experience in reference search starts outside of the search engine and the searcher generally knows something about the topic of the search but wants to find additional details. On the other hand, with real-time search, and social real-time search in particular, a searcher seeks to learn more about what is popular at that moment in time. A key quality measure for real-time search results is the ability of the search engine to provide a meaningful summary of the major topics in a user's newsfeed, and of the major topics in a set of search results.

The present invention also addresses problems experienced when creating effective advertising products for social media. Social media is traditionally a place where people come to interact with their friends, to exchange messages containing text, pictures, etc. Traditional search, of the sort offered by Google, for example, has a tremendously effective advertising product: pay-per-click advertising (PPC), based on keywords. The benefit of Google's PPC advertising is that it performs extremely well. Measured in terms of click-through rate, or CTR, Google's PPC ads deliver excellent results for advertisers. The reason for this is that a user who is conducting a search is expressing intent around the search term they're providing. By searching for something, a user is explicitly declaring interest and intent around the search term the user is employing. This means that ad content is correlated to the user's task, and acting on an ad is not interruptive to the user's task. This PPC advertising model does not, however, translate well to social media. The targeting in social media is typically based on demographic and psychographic parameters that describe the user. But the promise of social media lies in the tremendous engagement it offers. Users tend to generate many more page views inside social media than they do inside traditional search. The opportunity exists to create a more effective PPC-based advertising product for social media, and this is represented in embodiments of the current invention.

Consider, for example, that a topic model constructed from social media text represents what a user's friends, contacts, etc. are talking about. While a user may not have entered the social media engagement intending to search for any particular topic, when the user sees that his/her friends are discussing some specific topic, then the user is more likely to become interested in this topic and to conduct a search on the associated keywords, to find out what their friends are discussing, in more detail.

This is why we characterize the current invention as an excellent mechanism for manufacturing and harvesting intent in social media. The present methods and systems manufacture intent because it quickly advises a user what his or her friends are discussing. By trading on the social connections that a person has built, a topic model effectively manufactures interest on the part of the user with respect to topics of current discussion. By presenting the topic summary to the user in an actionable manner (where each topic can be selected to run a search), the current invention allows the user to express intent against specific topics. If a user's friends are discussing something in particular, then an advertisement on that same topic can be expected to work reasonably well. And, even better, once a user has expressed intent in a topic by selecting it (e.g., through a cursor control action or other indication), then topic-connected advertisements presented at that point can be expected to perform even better.

Just as the object of a real time search is different from the object of a reference search, so too are the metrics by which the quality or accuracy of the search results are measured. With reference search, breadth of coverage may be an important criterion for evaluating the quality or accuracy of the search results. For example, a searcher probably expects a good reference search engine to return as many definitional reference links as possible, ideally on the first page of the results. So, a search for “Saturn” can mean the automobile company, the planet, the Roman god, or the Apollo-era rocket, and since the context is not otherwise known the first page of results may include documents related to all of these topics.

Compare this with real-time search in a social newsfeed where the user experience starts inside the newsfeed data itself, and starts with discovery, not with search at all. When a searcher uses a real time social search tool and does not know what is being discussed in the newsfeed right now (i.e., what is popular, fashionable or trendy amongst the user's friends) at that particular moment, the user relies on the tool itself to help comprehend potential search topics. Hence, the user typically starts by selecting a topic that the real-time system advises is “hot” right now. In the case of the search for “Saturn”, the results will depend on what is happening (in terms of what the friends of the user are doing in the social network) at the time the search is initiated. Further, the “hot topics” produced in the manner discussed herein provide a summary of the key concepts contained in the real time search results.

Selecting any of the hot topics displayed in a browser application may then initiate a new search, using the selected topic as a new search term. This approach lets searchers engage with the real-time conversational material that's being summarized by the topic model. The inventors refer to this approach as “discovery-powered search”. Of course, the hot topic word map illustrated in the accompanying drawings is merely one way to summarize a set of search results and the present invention is not limited to such a presentation.

In reference search then, a searcher is mostly concerned with individual results and the coverage that those individual results have over the space of possible definitions for the search term(s). In real-time social search, no one single result is all-important. Instead, the goal is to provide the searcher an overall sense—covering the entire social newsfeed—of what is happening with respect to a specified topic, at the time the search is performed.

Importantly, real time social content reflects the “here and now” of the user's friend's lives. That is, the content in the user's newsfeed is a reflection of the moment-by-moment and contextual opinions, thoughts, attitudes, ramblings, and ideas of the user's friends. Social networks often provide this to consumers in an unfiltered, raw fashion, without editorial review or revision. As such, a user's real time newsfeed may bear little or no relation to “hard news” or facts. Nevertheless, this “voice of the crowd” has become an important component of the overall Web experience and many individuals and companies have sought to monetize it in some fashion.

One attempt to monetize the real time social Web involves the integration of conventional Web search results with so-called social real time Web search results. Internet search provider Google, Inc. of Mountain View, Calif., for example, has attempted to do just that by including search results from select feeds, blogs and news sites in-line with more traditional Web page search results using the same relevancy criteria as the Web page search. Displayed alongside these search results are “sponsored links”—paid-for advertisements which provide hyperlinks to the advertisers' respective web sites. If a Google™ user selects one of these sponsored links, the advertiser pays Google a previously agreed upon fee. This is known as a “pay per click” (PPC) or, from the advertiser's point of view, a “cost per click” (CPC) model.

Several variations of the CPC advertising model exist, but common to all of these models is the requirement that the advertiser (e.g., the seller of goods or services) try to predict what keywords will be used by searchers in connection with Google (or other search engine)-initiated searches. Obvious choices are those keywords which are descriptive or definitional of the product or service sought to be promoted. Less obvious, but perhaps still common, choices are complementary terms to those which describe or define the product or service. For example, the provider of dish washing liquid may wish to purchase keywords that describe flatware or dinnerware so that ads for the detergent will be displayed when a searchers searches for those terms.

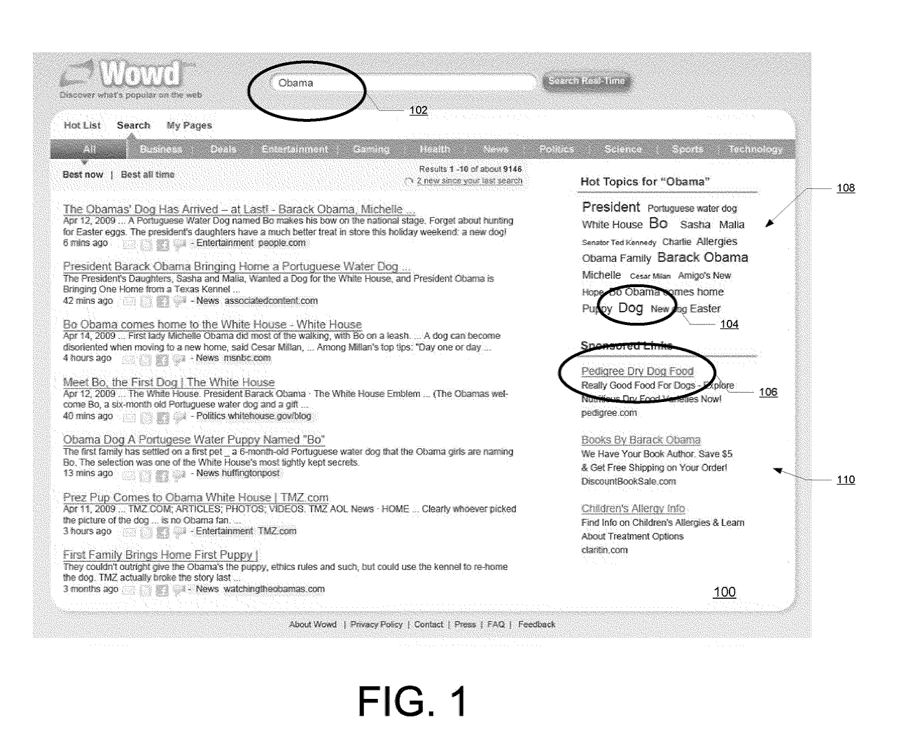

Missing from this keyword calculus, however, is a recognition that meaning of a search term may, and often does, vary with time. As illustrated in the screen shots 100 and 200 shown in FIGS. 1 and 2, respectively, a real time search for the term “Obama” 102 may one day be related to a new pet arriving at the White House (see FIG. 1) while the same search on a different day may be related to pending legislation dealing with healthcare insurance reform (see FIG. 2).

The present inventors refer to this phenomenon as the “information value of time”. Whereas stock traders and others are quite familiar with the time value of information (the notion that knowing some fact in advance of it being known by others can allow those in-the-know to capitalize on the information), the information value of time is a recognition that for a defined, often short, period of time, terms (e.g., search query keywords) can acquire special, contextualized meanings different than they might otherwise have at other times. This is true for web-wide real time search of the sort just described, and it is also true for personal real time social search in a single person's newsfeed. The present methods and systems provide means for capitalizing on the advantage of recognizing when those times occur and of providing advertisers specific means to act upon a term's time-dependent meaning with respect to their PPC advertising campaigns.

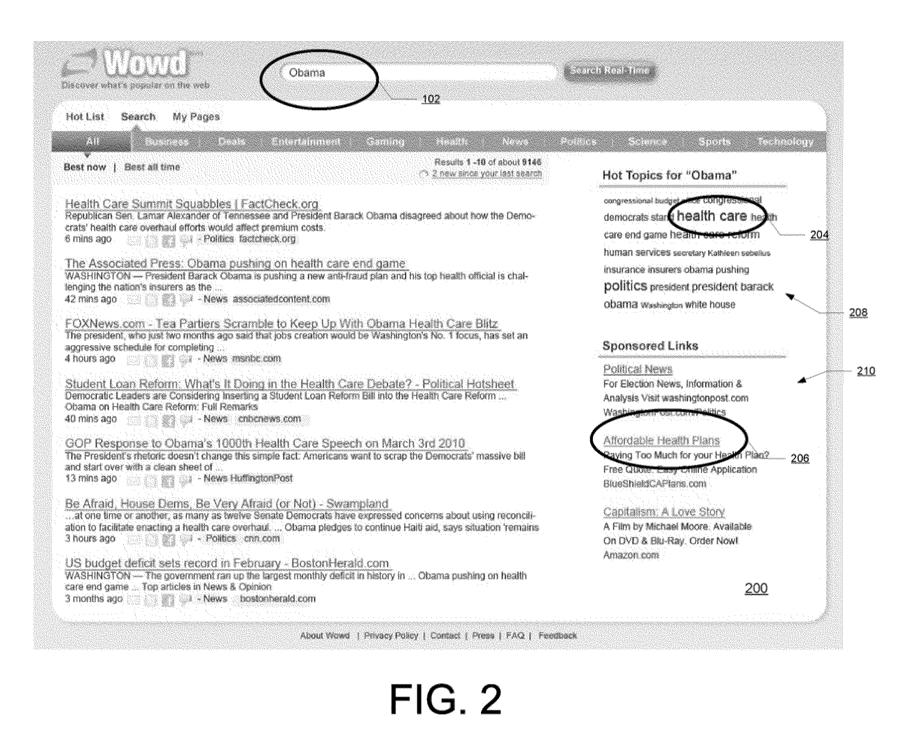

FIG. 3 illustrates the information value of time concept in a graphical fashion. The interest (as demonstrated, for example, by real time Web content) in a particular event, E, is plotted 300 against time, t. Prior to a time T1, the interest in event E is relatively low (or perhaps nonexistent). This is not surprising inasmuch as the event E has not yet occurred. At time T1, however, the interest in event E rises (sometimes sharply), as the event becomes important in the minds of people creating real time Web content. That interest remains high until a time T2, after which the interest wanes (or perhaps disappears altogether). The post-T2 interest may be greater than, less than or equal to the pre-T1 interest in the event, depending on the nature of the event, its aftermath, and many other factors. Importantly, for purposes of the present discussion, during the period T1 to T2, the interest in the event is sufficiently high so as to constitute a monetizable phenomenon.

Prior to time T1, an advertiser is generally limited to purchasing the knowable keywords that searchers (or other consumers) will associate with the advertiser's products or services. Hypothetically, the advertiser could purchase all keywords (or a significant number of same), but this would generally be regarded as an unsound business practice and so in practice it does not occur. However, the advertiser would not know to purchase keywords involved with event E because, by and large, the association of event E (or, more particularly, the interest in event E) with the advertiser's products or services cannot be reliably predicted in advance of T1. Nevertheless, for the period of time T1 to T2, there is significant. value to the advertiser in owning the keywords associated with event E because of the interest surrounding the event. The opportunity to sell to the advertiser the opportunity to advertise against those keywords for the period of time T1 to T2 therefore exists, if one can accurately recognize the association between the keyword associations, as they emerge in real-time, and the advertiser's products or services.

The present methods and systems expose the opportunities presented by the information value of time. As illustrated in FIGS. 1 and 2, in one embodiment of the invention, sponsored links 104, 204 for products or services that are contextually accurate or important with respect to the real time interest in results spawned by search keywords 102 are presented to users of a search engine. Importantly, the sponsored links are not simply determined on the basis of the actual search keywords used. Instead, the search results produced by the keywords, which search result are culled, at least in part, from the real time social Web and therefore represent the current interests of the user's friends in the topics associated with the search keywords, are analyzed to determine the events or topics of interest at the time the search results are produced and the results of that analysis are used as the basis for determining which advertisements (sponsored links) to display.

In this model, which may make use of any existing advertising monetization scheme (e.g., cost per click, cost per impression, etc.), the advertisers need not exercise special precognitive abilities to foresee the future associations between their products or services and a particular event. Instead, the advertisers may operate according to their customary practices of purchasing definitional and other keywords that the advertisers expect will be associated with their goods or services. For example, a pet food company may continue to purchase keywords such as “dog” 104. In accordance with the present invention, however, when a search of the real time Web or social news stream reveals that these purchased keywords are implicated in a strong association with interest in an event (which event is recognized through a search that is initiated through the use of different keywords), the advertisements can be presented. So, in FIG. 1, a pet food company that purchased the key word ‘dog” has its advertisement displayed, even though the subject search was for “Obama”. In FIG. 2, the same search keyword, “Obama”, led to search results that reflected the nation's interest in health care insurance reform legislation, and so an advertisement for “Affordable Health Plans” 206, determined on the basis of keywords, “health care” 204, which were purchased by the insurance provider, was presented.

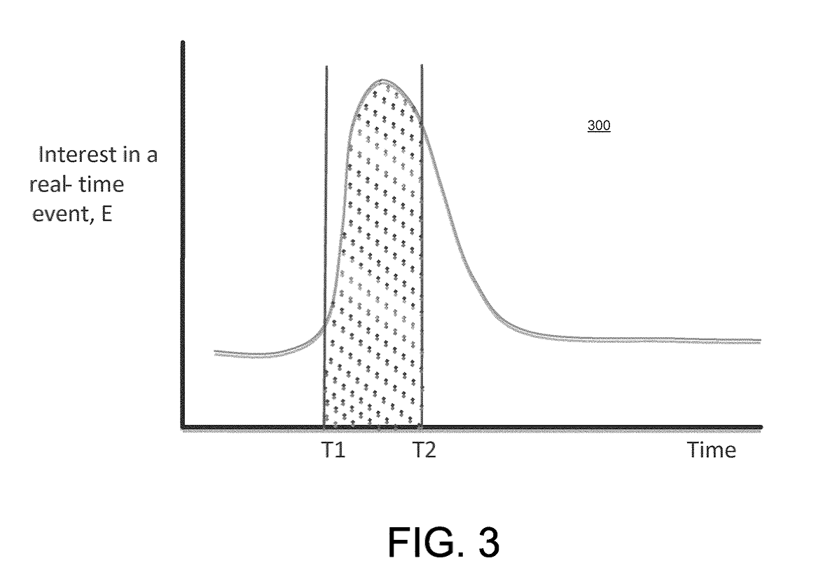

FIG. 4 illustrates a process 400 for statistical processing of search results returned in response to a search query to build a topic model of n-grams which may be used as potential keyword-based search queries for the presentation of on-line advertisements, in accordance with an embodiment of a present invention. At 402, a search request is received. The search request includes one or more search keywords. The request is received at a search engine, which may be resident at the same computer system at which the search query is provided (e.g., for a desktop search or a search submitted through a client resident on a personal computer, mobile device, smart phone, iPad™, etc.), or at a computer system remote from where the request originated (e.g., at a server communicatively coupled to a client computer system at which the request originated, for example, via a client application or a Web browser). Responsive the request, at 404 the search engine produces search results for the search keyword.

In one embodiment of the invention, as discussed in greater detail in U.S. patent application Ser. No. 12/608,966, filed 29 Oct. 2009, now U.S. Pat. No. 7,716,205, incorporated herein by reference, the search results include linked documents (e.g., Web pages, real time Web content, etc.), ranked by observing link selections for referred documents from referring documents and counting such selections. The counts for each of the link selections may be stored at various computer systems, including but not limited to a distributed network, an individual computer, a centralized network of computers connected through a local network, or a hybrid system consisting of combinations of the foregoing, and processed (e.g., using a discrete probability distribution defined by the counts of the link selections) to obtain page ranks for the referred documents. The link selections may be observed by a browser extension running on individual ones of the computer systems of the distributed network. Counts of the link selections may be stored at locations within a distributed network determined by a distributed hash table or another such arrangement of nodes in a network with a logarithmic network diameter where the time to find any node is a logarithmic function of the size of the network. In other embodiments, counts of the linked sections may be stored on a centralized system that includes a collection of computers connected through a local network or a hybrid system comprised of a combination of distributed and centralized systems. The search results may be displayed in a ranked order as determined by the page ranks 406.

In some instances, as explained in U.S. patent application Ser. No. 12/608,922, filed 29 Oct. 2009, incorporated herein by reference, the search results will be Web sites that are deemed most similar to the subject of the search query. Information regarding each of the Web sites may be retrieved from a data structure stored at a location within a distributed system identified by a distributed hash table. Similarity between the subject query and various Web pages may be estimated according to a scalar product of vectors representing the subject query and each respective Web page. These vectors are updated, for example in response to user visits to the associated Web pages and according to maturity factors associated with each respective user that visits the respective Web page. The user visits may include references by virtual users and/or ratings by oracles. In another embodiment of the invention, information regarding Web sites is stored in a hybrid data structure consisting of a distributed system and a centralized system that includes multiple computers connected through a local network.

At 408, the search results (e.g., the ranked set of Web pages and real time Web content) are analyzed to develop a set of “hot topics”. At 410, and as shown in FIGS. 1 and 2, the hot topics list may be displayed as a “word cloud” 108, 208. The word cloud is a visual depiction of n-grams in which the relative font size, color, and/or other attributes of each n-gram in the word cloud may be used to represent the popularity/prevalence/frequency of occurrence of the n-gram in the space of the search results over which the word cloud is created. This word cloud reveals the context in which the search query keyword(s) appear in the search results. Common words, prepositions, articles and other information may be filtered out of the word cloud so that only meaningful n-grams are displayed and acted upon. The word cloud is produced, in one embodiment of the invention, by forming a statistical topic model across the collection of Web pages and real time Web content that forms the search results (or a subset of those results).

There are a variety of methods for producing statistical n-gram models from an underlying set of documents (e.g., Web pages) or materials, any (or all) of which may be used in the context of the present invention. For example, topic model construction based on bag of words assumptions may be used. So too may topic models that discover topics as well as topical phrases and/or methods for topic inference based on Gibbs sampling, variational inference, and/or text classification be used. Both Latent Dirichlet Allocation and Correlated Topic Model techniques can be used, see, e.g., Blei, David M. and Lafferty, John D., “A Correlated Model of Science”, Ann. Appl. Stat., v. 1, no. 1, pp. 17-35 (2007). Other algorithms will also often produce acceptable results. The specific algorithms by which the statistical n-gram model is produced is not critical to the present invention.

It is the hot topic n-grams, or a subset thereof, that are used as the basis for determining which sponsored links (i.e., advertisements or other messages) 110, 210 to display at 412. In FIG. 4 this is shown as a parallel operation to the display of the hot topics but in practice in may be performed serially therewith, either preceding or following the display of the hot topics. Thus, advertisers that have purchased keywords that correspond to the hot topics may have their advertisements displayed even though the actual search keyword(s) were not reserved or purchased by those advertisers.

FIG. 1 illustrates an example where the search term “Obama” produced real time search results that included the hot topic “Dog” 104 and, consequently, an advertisement 106 for pet food was displayed because the advertiser had purchased the keyword “dog”. Likewise, in FIG. 2, the search term “Obama” 102 produced search results where the hot topics included “Politics” and “Health Care” 204, and consequently sponsored links 210 for political news and health insurance 206 were displayed because associated advertisers had purchased or reserved those keywords.

Thus, the present invention provides for the placement of advertisements or other messages (although discussed in the context of advertisements, the sponsored links which are shown in response to the existence of a keyword in a hot topic word map can be any kind of content and need not be advertisements) according to a real time association of events and keywords as revealed by the contextual conversations that surround search keywords within the real time Web and, further, provides the opportunity to capitalize on those associations. Traditional advertisement placement cannot respond to these real time opportunities and so the event windows during which the associations of keyword and events will be missed opportunities from the standpoint of both the party seeking to place an ad and the party seeking to sell the ad space.

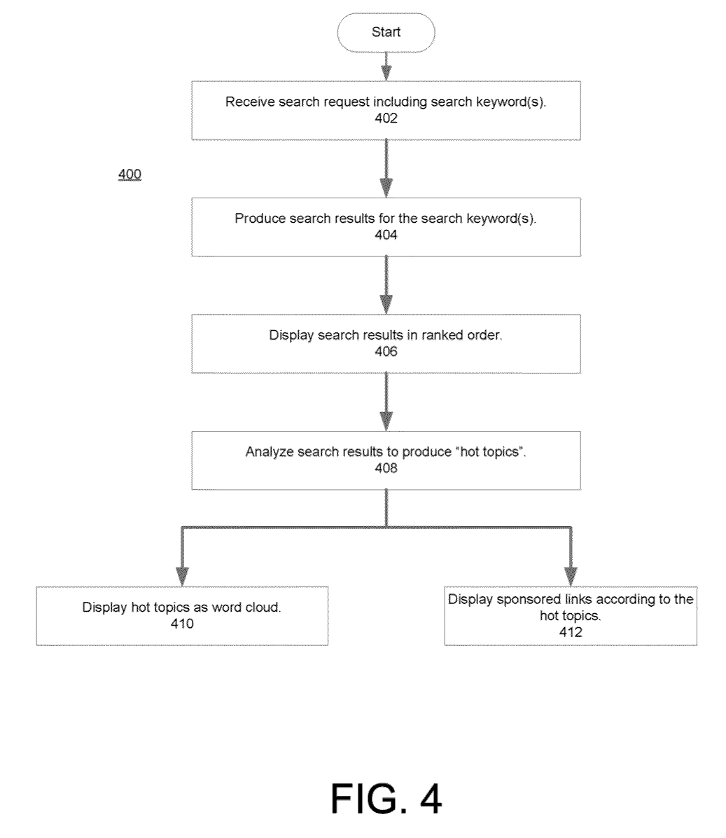

In some instances, the search keywords may be “synthetic” keywords. That is, the keywords may not truly exist in the sense that a searcher entered the term(s) in a search query. Instead, a shown in screenshot 500 of FIG. 5, the searcher (or user) may have simply selected a category 502 of real time Web content (such as “Entertainment”) as a shorthand method of seeking a list of search results showing the latest news or other real time Web content related to that category (the categorization of content may be made on any of several bases, including user-defined categorizations, automated categorizations and/or a combination of these processes).

In response to the selection, the word map 508 is generated for the hot topics identified by analysis (e.g., statistical topic modeling) of the returned results. As shown in this example, the results produced a hot topic 504 with a 3-gram “Corey Haim collapsed”. This hot topic, in turn, was used as a keyword to determine that a sponsored link 506 for “remembering Corey Haim” should be displayed. A related situation is “discovery-related search” in which selection of a content source (e.g., a particular Web site or portal) is treated as a de-facto search to determine what is popular (in terms of viewership) at that site. The search results will be the ranked list of popular content items at the site and the hot topics will be produced from that universe of search results. These hot topics will, in turn, be used to determine the sponsored links for display.

Determining which advertisements or other content to display as sponsored links or otherwise is based on the hot topic keywords revealed by the analysis of the search results. This may be done in a conventional fashion by consulting an ad server or other data store and providing the hot topic n-gram as an input to receive the associated advertisement or other output. The manner in which the advertisement or other output is selected based on the provided n-gram may depend on a current bid price by prospective advertisers for that n-gram or on another contractual basis that exists between the advertiser and a service provider (which need not be the same service provider that is providing the Web service that implements the present invention).

In some instances, advertisers may not want their advertisements or other content displayed as a sponsored link even if the analysis of search results reveals hot topics that correspond to keywords purchased by that advertiser. This may arise, for example, if other content or context in which the keywords that ordinarily would trigger the display of a sponsored link appear also include content that the advertisers believes would reflect negatively on the advertiser, its products and/or its services. For example, church groups that purchase keywords such as “faith” or “religion” may not want their sponsored links appearing if the context of the search results also reveals topics such as “fanaticism” or “terror”. The present invention can accommodate such desires by examining both positive and negative n-grams that appear in the word maps that are constructed from search results and exclude sponsored links if undesirable n-grams appear in those word maps.

The word maps that comprise the hot topics displayed to a searcher (or user) may be determined on the basis of the frequency with which those n-grams appear in the search results. Not all of the n-grams will be displayed in the word map, but the computation for n-grams that are not displayed may be made and stored so as to facilitate the above-described processes. In practice, it will often be the case that only a few n-grams (those which appear most frequently) will be displayed in the word maps so as not to obscure other elements of the search results page. The search results over which the word maps are computed are, generally, drawn from the universe of Web content or social newsfeed content that is receiving attention at the time the search is performed. That is, the web content that has received “votes” as determined by user visits to the associated Web pages (or other constructs) at which the content is displayed or otherwise provided. The inventors call this universe of Web content, the “attention frontier”.

One of the interesting outcomes provided by the present invention is the notion of serendipitous product placement. This is the situation where searches for “x” lead to the presentation of ads for “y” because of the lucky (from the point of view of the “y” producer) happenstance that the attention frontier has associated “x” with keywords that were purchased for “y” in the zeitgeist of time that the search is performed. Thus, notwithstanding that the “y” producer has not purchased keyword(s)“x”, the “y” producer benefits from the real time association by having searches for “x” yield the y-related keywords that the “y” producer did purchase.

Another interesting outcome is the unintended product comparison in which searches for product “p” lead to the presentation of ads for competitor product “q”. The producer of product “q” benefits from searches for product “p” simply because the real time or social Web has produced search results in which “p” and “q” (or at least q-related keywords) are mentioned together a sufficient number of times for “q”-related keywords to be recognized as hot topics that cause q-related ads to be obtained and displayed. Notice in the above example, the “q” producer did not need to purchase “p” as a keyword (an action which may have legal consequences) and nevertheless had a q-related sponsored link displayed as the result of a p-focused search.

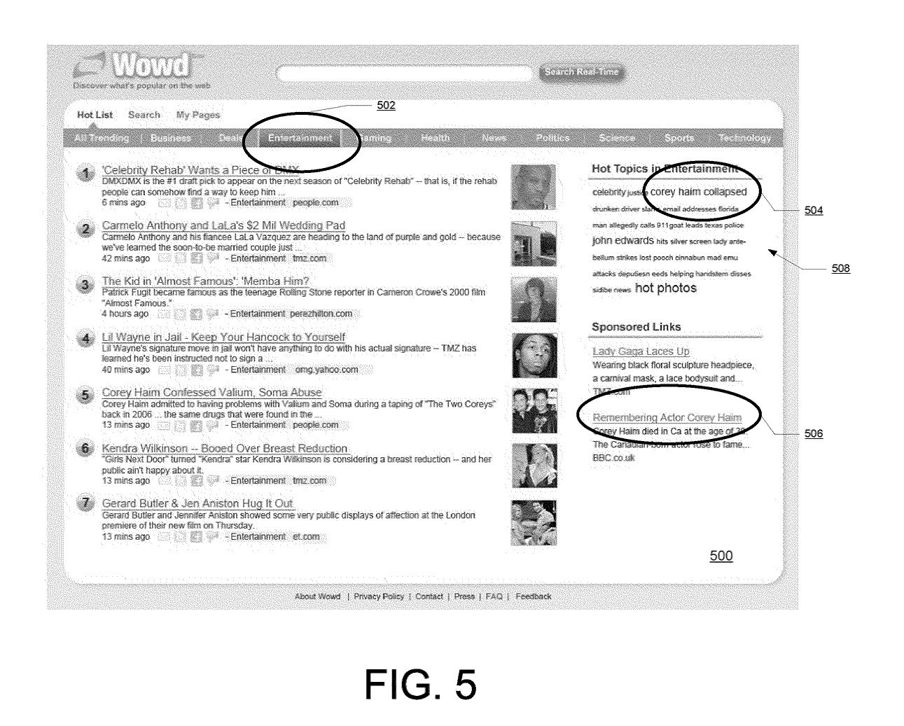

The search-related user interface is but one possible implementation for a system that uses the present invention. Another instantiation concerns a real time keyword extension tool. As illustrated in FIG. 6, such a tool 600 will receive a vector of keyword(s) (e.g., in the form of a list contained in a spreadsheet or other formatted schema) 602 and will output an expanded set of keywords (e.g., in the form of a list contained in a spreadsheet or other formatted schema) 604. The expanded set of keywords is the statistical topic model (i.e., the set of hot topics) that includes the keywords culled from a search of the real time Web that is run by the tool. The keywords in the expanded list may be associated with weights to reflect their relative prevalence or frequency of use within the attention frontier in the context of the input keywords. The tool may exist as a client application for a computer system, mobile device, etc., or may exist as a Web service accessible via a Web browser and/or client application.

A further instantiation of the present invention concerns an application programming interface (API) provided by a Web service. Programmers for other Web sites or services may construct those sites or services to pass keywords to the API and to receive back the vector of expanded keywords produced in a fashion similar to that described above. This Web service with its API may be useful in paradigms where the keyword expansion service is licensed on a per use or other basis but is not itself associated with a proprietary Web site. Of course, other instantiations and implementations of the present invention are possible and the list of services and sites presented herein is intended merely to illustrate examples in which the present invention finds application.

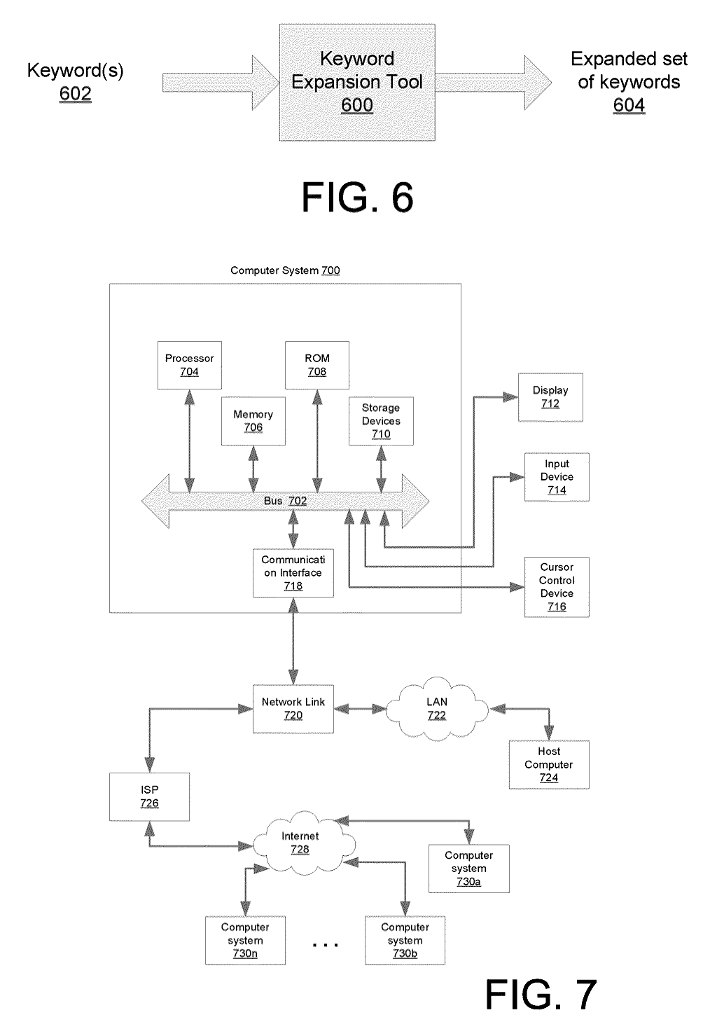

FIG. 7 illustrates a computer system 700, upon or with which the methods of the present invention may be practiced. Computer system 700 includes a bus 702 or other communication mechanism for communicating information, and a processor 704 coupled with the bus 702 for processing information. Computer system 700 also includes a main memory 706, such as a RAM or other dynamic storage device, coupled to the bus 702 for storing information and instructions (such as instructions comprising the link selection monitoring software when the program is running) to be executed by processor 704. Main memory 706 also may be used for storing temporary variables or other intermediate information during execution of instructions to be executed by processor 704. Computer system 700 further includes a ROM 708 or other static storage device coupled to the bus 702 for storing static information and instructions for the processor 704. A storage device 710, such as a hard disk, is provided and coupled to the bus 702 for storing information and instructions (such as instructions comprising the methods discussed herein).

Computer system 700 may be coupled via the bus 702 to a display 712 for displaying information to a computer user. An input device 714, including alphanumeric and other keys, is coupled to the bus 702 for communicating information and command selections to the processor 704. Another type of user input device is cursor control device 716, such as a mouse, a trackball, or cursor direction keys for communicating direction information and command selections to processor 704 and for controlling cursor movement on the display 712.

Computer system 700 also includes a communication interface 718 coupled to the bus 702. Communication interface 708 provides for two-way, wired and/or wireless data communication to/from computer system 700, for example, via a local area network (LAN). Communication interface 718 sends and receives electrical, electromagnetic or optical signals which carry digital data streams representing various types of information.

For example, two or more computer systems 700 may be networked together in a conventional manner with each using a respective communication interface 718.

Network link 720 typically provides data communication through one or more networks to other data devices. For example, network link 720 may provide a connection through LAN 722 to a host computer 724 or to data equipment operated by an Internet service provider (ISP) 726. ISP 726 in turn provides data communication services through the Internet 728, which, in turn, may provide connectivity to multiple remote computer systems 730a-730n (any or all of which may be similar to computer system 700. LAN 722 and Internet 728 both use electrical, electromagnetic or optical signals which carry digital data streams. Computer system 700 can send messages and receive data through the network(s), network link 720 and communication interface 718.

As should be apparent from the foregoing discussion, various embodiments of the present invention may be implemented with the aid of computer-implemented processes or methods (i.e., computer programs or routines) or on any programmable or dedicated hardware implementing digital logic. Such processes may be rendered in any computer language including, without limitation, a object oriented programming language, assembly language, markup languages, and the like, as well as object-oriented environments such as the Common Object Request Broker Architecture (CORBA), Java™ and the like, or on any programmable logic hardware like CPLD, FPGA and the like.

It should also be appreciated that the portions of this detailed description that are presented in terms of computer-implemented processes and symbolic representations of operations on data within a computer memory are in fact the preferred means used by those skilled in the computer science arts to most effectively convey the substance of their work to others skilled in the art. In all instances, the processes performed by the computer system are those requiring physical manipulations of physical quantities. The computer-implemented processes are usually, though not necessarily, embodied the form of electrical or magnetic information (e.g., bits) that is stored (e.g., on computer-readable storage media), transferred (e.g., via wired or wireless communication links), combined, compared and otherwise manipulated. It has proven convenient at times, principally for reasons of common usage, to refer to these signals as bits, values, elements, symbols, keys, numbers or the like. It should be borne in mind, however, that all of these and similar terms are to be associated with the appropriate physical quantities and are merely convenient labels applied to these quantities.

Unless specifically stated otherwise, it should be appreciated that the use of terms such as processing, computing, calculating, determining, displaying or the like, refer to the action and processes of a computer system, or similar electronic computing device, that manipulates and transforms data represented as physical (electronic) quantities within the computer system's registers, memories and other storage media into other data similarly represented as physical quantities within the computer system memories, registers or other storage media. Embodiments of the present invention can be implemented with apparatus to perform the operations described herein. Such apparatus may be specially constructed for the required purposes, or may be appropriately programmed, or selectively activated or reconfigured by a computer-readable instructions stored in or on computer-readable storage media (such as, but not limited to, any type of disk including floppy disks, optical disks, hard disks, CD-ROMs, and magnetic-optical disks, or read-only memories (ROMs), random access memories (RAMs), erasable ROMs (EPROMs), electrically erasable ROMs (EEPROMs), magnetic or optical cards, or any type of media suitable for storing computer-readable instructions) to perform the operations. Of course, the processes presented herein are not restricted to implementation through computer-readable instructions and can be implemented in appropriate circuitry, such as that instantiated in an application specific integrated circuit (ASIC), a programmed field programmable gate array (FPGA), or the like.

Thus, methods and systems for statistical processing of search results returned in response to a search query to build a topic model of n-grams that are present in documents or other materials that comprise search results, where the n-grams may be used both as subsequent search queries and also as potential triggers for the presentation of on-line advertisements have been described. Although discussed with reference to certain examples, the present invention should not be limited thereby.

What is claimed is:

1. A computer-implemented method, comprising:
responsive to receipt of a search keyword at a first computer system, retrieving one or more of real time Web search results or filtered newsfeed results for the search keyword;
analyzing the real time Web search results or filtered newsfeed results, as applicable, to build a topic model of n-grains for the real time Web search results;
treating the n-grams of the topic model as ad-based keywords to determine advertisements to be displayed in conjunction with the real time Web search results or filtered newsfeed results, as applicable; and
displaying the real time Web search results or filtered newsfeed results, as applicable, and the advertisements.

2. A method, comprising presenting for display sponsored links for products or services that are contextually accurate or important with respect to real time interests of Web users in search results spawned by search terms submitted to a search engine, wherein the sponsored links are determined by their associations with said real time interests as represented by keywords different from the search terms and produced from an analysis of current interests of the Web users in topics associated with the keywords as determined by culling the search results produced by submitting the search terms to the search engine.

3. The method of claim 2, wherein the keywords representing the real time interests are presented for display as a word cloud in conjunction with the sponsored links and the search results.

4. The method of claim 3, wherein the word cloud is a visual depiction of n-grams in which relative attributes of each respective n-gram in the word-cloud represents popularity, prevalence and/or frequency of occurrence of the respective n-gram in a space defined by the search results over which the word cloud is created.

5. The method of claim 4, wherein common words, prepositions, articles and other information are filtered out of the word cloud prior to presentation of the word cloud for display.

6. The method of claim 4, wherein the word cloud is produced by forming a statistical topic model across at least a subset of the search results.

7. A method, comprising displaying content responsive to receipt of a search query, said content selected by a computer system according to a real time association of events and keywords as revealed by contextual conversations that surround the search query within a real time Web.

8. The method of claim 7, further comprising offering for sale the keywords.

9. The method of claim 7, wherein the content comprises sponsored links.

10. The method of claim 7, wherein the content is displayed in conjunction with search results for the search query.

11. The method of claim 7, wherein the search query comprises a synthetic search query representative of a predetermined search category.

12. A computer-implemented method, comprising:
responsive to receipt of a search keyword at a first computer system, retrieving real time search results for the search keyword;
analyzing the real time search results to build a topic model of n-grams for the real time search results;
treating the n-grams of the topic model as keywords to determine content to be displayed in conjunction with the real time search results; and
displaying the real time search results and the content.

13. The method of claim 12, wherein the real time search results are retrieved from the same first computer system at which the search keyword is received.

14. The method of claim 12, wherein the content to be displayed in conjunction with the real time search results is obtained from the same first computer system at which the search keyword is received.

15. The method of claim 12, wherein the real time search results are obtained from different computer systems than those from which the content to be displayed in conjunction with the real time search results is retrieved.

16. A method, comprising statistically processing search results returned in response to a search query to build a topic model of n-grams that are present in documents included in the search results, using the n-grams as subsequent search queries to return subsequent search results and also as triggers for the presentation of additional content, and providing for display the additional content triggered for presentation by the n-grams along with the n-grams and the search results returned in response to the search query.

17. The method of claim 16, wherein the search query is received at a search engine resident at a computer system at which the search query is provided.

18. The method of claim 16, wherein the search query is received at a search engine resident at a computer system different from that at which the search query is provided.

19. The method of claim 16, wherein the additional content comprises advertisements.

20. A method, comprising determining content to display based on hot topic keywords revealed by an analysis of search results returned by a search engine in response to a search query different than the hot topic keywords; and providing said content for display along with the search results.

21. The method of claim 20, wherein the content comprises advertisements retrieved from an ad server.

22. The method of claim 21, wherein the hot topic keywords comprise n-grams and said n-grams are provided as an input to the ad server.

23. The method of claim 21, wherein the advertisements are determined according to a current bid price by prospective advertisers for respective n-grams which comprise the hot topic keywords.

24. A method, comprising receiving a vector of keywords at a keyword expansion tool and providing as an output of the keyword expansion tool an expanded set of keywords, wherein the expanded set of keywords is a statistical topic model that includes keywords culled from a search of a real time Web which is run by the tool.

25. The method of claim 24, wherein those keywords in the expanded set of keywords are each associated with weights to reflect their relative prevalence or frequency of use within an attention frontier in the context of the vector of keywords input to the tool.

26. A Web-based computer system, comprising a programming interface to a keyword expansion tool configured to receive a vector of keywords and to provide in response thereto an expanded set of keywords, wherein the expanded set of keywords is a statistical topic model that includes keywords culled from a search of a real time Web which is run by the tool.
